(19) United States
(12) Patent Application Publication
(10) Pub. No.: US 2008/0178504 A1
(43) Pub. Date: Jul. 31, 2008

(54) SYSTEM AND METHOD FOR DISPLAYING ADVERTISING

(76) Inventors: Terrance POPOWICH, Toronto (CA); Ian Hessel, Toronto (CA); Walter Wolanczyk, Barrie (CA)

Correspondence Address: TORYS LLP, 79 WELLINGTON ST. WEST, SUITE 3000, TORONTO, ON, M5K 1N2, omitted

(21) Appl. No.: 11/957,016

(22) Filed: Dec. 14, 2007

Related U.S. Application Data
(60) Provisional application No. 60/911,236, filed on Apr. 11, 2007.
(60) Provisional application No. 60/871,507, filed on Dec. 22, 2006.
(60) Provisional application No. 60/870,258, filed on Dec. 15, 2006.

(51) Int. Cl. G09F 19/00; G09F 17/00

(52) U.S. Cl. 40/602; 40/606.03; 40/606.01; 40/604

(57) ABSTRACT

The invention provides apparatus useful for the display of advertising materials on advertising space(s) extending from a portable structure(s) 100. In some embodiments, the advertising space is provided on frame or auxiliary structure(s) 104 connected to the primary structure(s) 100. In some such embodiments, the auxiliary structure(s) 104 extends skywards from the main structure(s) 100, but in other embodiments it may extend in other directions. Thus for example in various embodiments such structure(s) 104 may be attached to the tops of such primary structure(s) 100. Both the primary and auxiliary (advertising supporting) structures may be composed of modular components that can be assembled and de-assembled as, for example, frames 104. The auxiliary structure(s) 104 may be connected to the main structure(s) 100 directly, e.g. by way of attachments integrated into the main structure 100 or indirectly, e.g. by way of non-integrated attachments, such as hook and cable system 1210 attached to the ground or to other support structures.

### PRIORITY CLAIM AND INCORPORATION BY REFERENCE

This application claims the benefit of and incorporates by this reference U.S. provisional patent applications 60/911,236 entitled SYSTEM AND METHOD FOR DISPLAYING ADVERTISING AND TRACKING VIEWINGS THEREOF and filed 11 Apr. 2007; 60/871,507 entitled SYSTEM AND METHOD FOR DISPLAYING ADVERTISING AND TRACKING VIEWINGS THEREOF and filed 22 Dec. 2006; 60/870,258 entitled SYSTEM AND METHOD FOR DISPLAY OF ADVERTISING, AND METHODS OF TRACKING VIEWINGS THEREOF and filed 15 Dec. 2006; including all appendices and other documents attached thereto.

### BACKGROUND

The invention relates to advertising, and particularly to methods useful for the display of advertising in portable, relocatable, temporary, or otherwise moveable structures such as portable toilets, trailers, waste bins, and the like.

Portable or temporary structures, such as portable toilets, waste bins, trailers, and other moveable accommodations provide surfaces that advertisers can use with unique effectiveness to promote their products or services. However, such surfaces are largely constrained by the portable structure's characteristics—in terms of size, shape, and other related attributes such as orientation.

Additionally, affixing advertisements to a portable structure's surface presents challenges. For example, portable structures are often made of thick and heavy duty plastic molded into multi-planar and otherwise irregular structures, which makes it difficult to find a suitable surface for securing advertising materials.

There thus remains a need for improved systems and methods for displaying advertising on portable structures.

For purposes of this disclosure, the terms “portable” and “moveable” are synonymous, unless otherwise clearly required by the context of their use.

### SUMMARY OF THE INVENTION

In an aspect of the invention there is an apparatus for the display of advertising materials. The apparatus comprises at least one portable structure and a frame removably attached to at least one exterior surface of the at least one portable structure and configured to display advertising material. The frame may be mounted on the at least one portable structure and may have at least one surface for advertising material that is oriented to be viewed by an observer when outside the at least one portable structure.

The frame may be removably attached to the at least one portable structure. The frame may be removably attached by one or more direct connections that may comprise nuts and bolts, adhesives, or magnets. The frame may be removably attached to the at least one portable structure by one or more indirect connections that may comprise at least one of the one or more indirect connections comprises cables, clamps or ties. The one or more indirect connections attach to the at least one portable structure and a foundation.

The advertising material may comprise a banner that may have at least one side secured to at least one side of the frame and may be configured to allow air to pass therethrough. The apparatus may be configured to allow illumination of the banner. The advertising material may comprise a mounted sign that may be a rigid sign, a metal sign, a board, a plastic sign and a poster. The advertising material may comprise one or more electronic display devices that may be a plasma screen, a liquid crystal display (LCD) and Cathode Ray Tubes.

The apparatus may comprise a plurality of portable structures disposed adjacent to each other, and a single frame attached thereto to create a bank of portable structures supporting an advertisement.

In another aspect of the invention there is an apparatus for the display of advertising materials. The apparatus comprises a frame removably attached to at least one exterior surface of at least one portable structure and configured to display advertising material. The frame may be mounted on the at least one portable structure and may have at least one surface for advertising material that is oriented to be viewed by an observer when outside the at least one portable structure.

The frame may be removably attached to the at least one portable structure. The frame may be removably attached by one or more direct connections that may comprise nuts and bolts, adhesives, or magnets. The frame may be removably attached to the at least one portable structure by one or more indirect connections that may comprise at least one of the one or more indirect connections comprises cables, clamps or ties. The one or more indirect connections attach to the at least one portable structure and a foundation.

The advertising material may comprise a banner that may have at least one side secured to at least one side of the frame and may be configured to allow air to pass therethrough. The apparatus may be configured to allow illumination of the banner. The advertising material may comprise a mounted sign that may be a rigid sign, a metal sign, a board, a plastic sign and a poster. The advertising material may comprise one or more electronic display devices that may be a plasma screen, a liquid crystal display (LCD) and Cathode Ray Tubes.

The apparatus may comprise a plurality of portable structures disposed adjacent to each other, and a single frame attached thereto to create a bank of portable structures supporting an advertisement.

### BRIEF DESCRIPTION OF THE FIGURES

The invention is illustrated in the figures of the accompanying drawings which are meant to be exemplary and not limiting, in which like references are intended to refer to like or corresponding parts, and in which:

FIGS. 1-5, 13 and 14 are schematic diagrams of embodiments of systems for displaying advertising in accordance with the invention;

FIGS. 6-9, 11 and 12 are schematic diagrams of embodiments of brackets in accordance with the invention; and

FIG. 10 is a schematic diagram of an embodiment of a hook and cable system in accordance with the invention.

### DETAILED DESCRIPTION OF THE PREFERRED EMBODIMENTS

The description which follows, and the embodiments described therein, are provided by way of illustration of particular embodiments of the principles of the present invention. These examples are provided for the purposes of explanation, and not limitation, of those principles and of the invention.

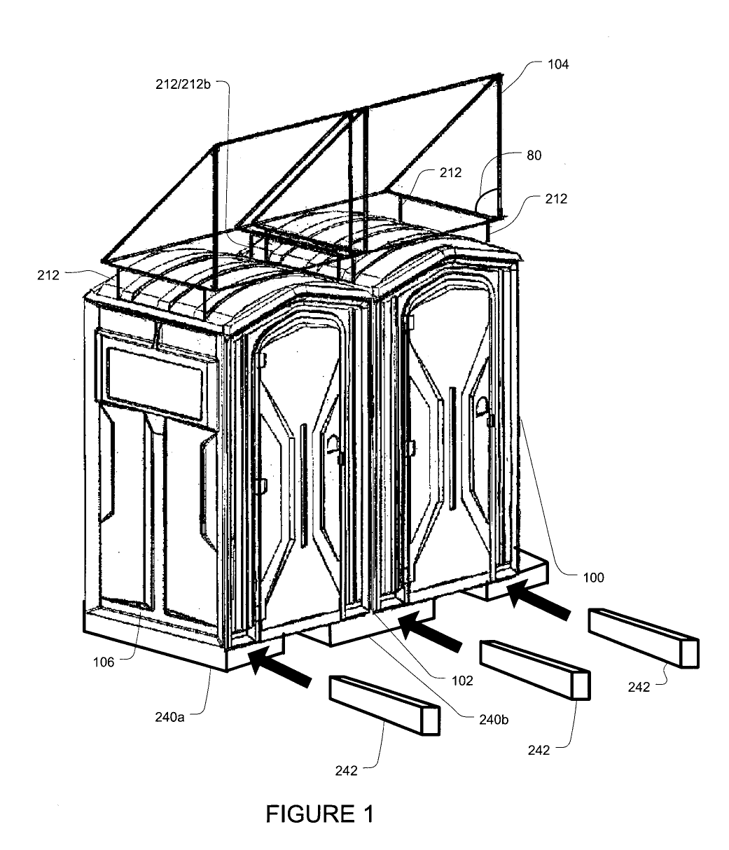

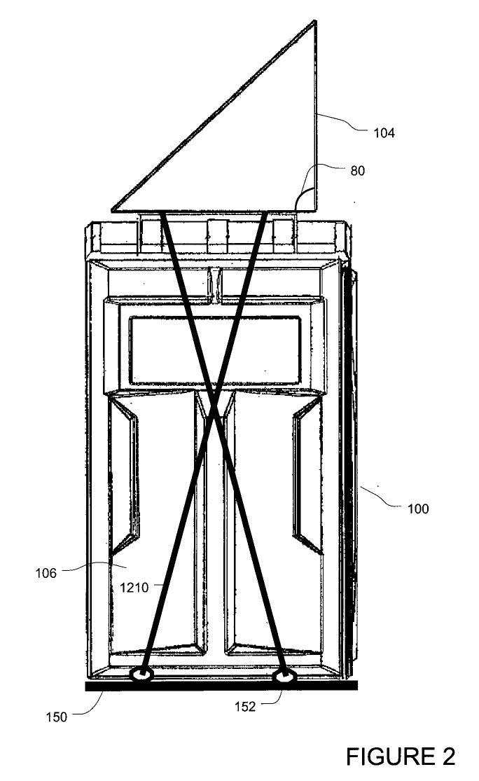

FIGS. 1 and 2 provide schematic diagrams of apparatus according to the invention. In the example shown, primary structure 100 comprises two portable restrooms connected at location 102. As used herein, “portable structure” may refer to an individual portable structure 100, or more than one portable structure 100, as in FIG. 1, which may alternatively be referred to as one or more banks of portable structures. A frame or other auxiliary structure 104 is connected, or removably attached, to structure 100, and may extend across one or more portable structures 100, as described herein. Frame 104 may for example rest upon structure 100 via one or more leg structures 212, as shown in FIG. 1 and as described herein.

Advertising may be shown or otherwise provided on auxiliary structure 104. Structure 104 may be provided with interior and/or exterior illumination to improve viewing of any advertising material shown thereon. Such illumination may be provided by one or more light sources located inside or outside portable structure 100, attached to a surface thereof, attached to frame 104, or that otherwise directs light at the advertising material.

The surfaces of advertising materials supported by auxiliary structure(s) 104 may be provided at any angle(s) suitable for facilitating viewing by the intended audience. For example, angle 80 in FIGS. 1,2 may be any angle between 0-180 degrees. In many embodiments of the invention adapted for use with commonly-used portable restrooms, angle 80 may be any angle between 45 and 135 degrees, and, in some preferred embodiments of that type, between about 80 and 110 degrees. While any angle between zero and about 270 degrees can be used, a desirable angle may be 80 degrees or less, as shown in FIGS. 1 and 2. Such angles for arrangement of frame 104 may be one characteristic of the connection between structure 104 and portable structure 100 that orients advertising material to be viewed by an observer that is outside of portable structure 100. Other characteristics may include the size of the advertising material and how far above the portable structure the advertising material is located at (which may be at least partially determined by leg structures 212) and the relative location of the intended viewing audience.

Portable structure 100 may further comprise one or more channels 240 located thereunder. As shown in FIG. 1, channel 240 may be wide enough to fit therein one or more bottom edge(s) or other feature(s) of portable structure 100, and still have room for one or more ballasts 242 to be inserted into channel 240. Ballast 242 may be adjustable in weight, which can be customized for holding a portable structure and its associated auxiliary structure in a stable position, for example, under varying wind or other conditions. In FIG. 1, channel 240a is designed to be more narrow to fit one “leg” edge of a portable structure(s) and a ballast 242, while channel 240b is designed to be wider to fit ballast 242 and two leg edges of adjacent portable structures. In other embodiments, the brackets, such as brackets 800 and 900 described herein, may be modified to serve the same function as channels 240 and accommodate one or more ballasts 242.

In various embodiments, frame 104 may be secured to portable structure 100 by way of direct connections such as adhesives, nuts and bolts, magnets or brackets 800 and 1000 as described herein, and/or by indirect connections (that connect frame 104 and portable structure 100 via one or more other devices, structures or elements) such as cables, clamps, ties or hook and cable system 1210, as shown in FIG. 2 and described herein. Note in FIG. 1, bracket 1000 is hidden from view at location 102 and therefore is not shown in the Figure.

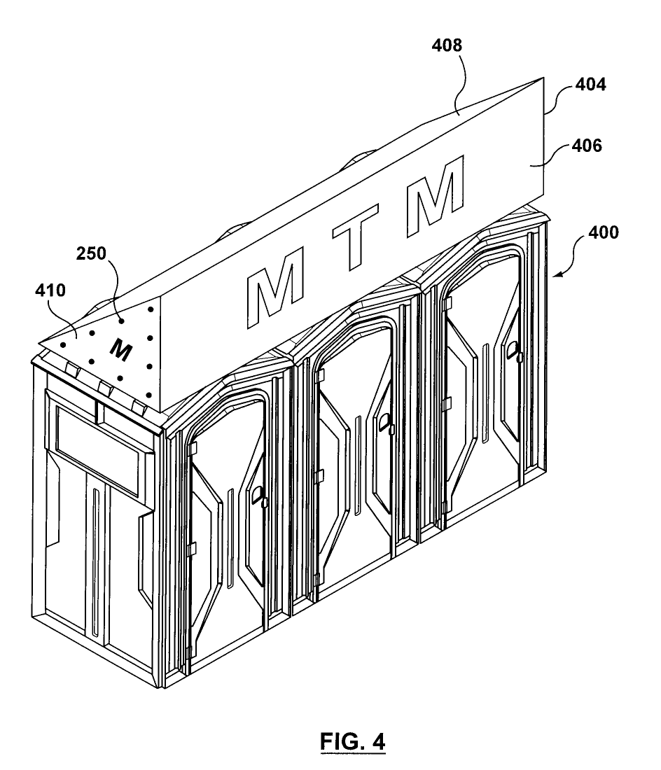

An advertising banner, mounted sign, poster or other advertising material to be used with an auxiliary structure, is preferably made with one or more materials having desirable physical characteristics relating to, for example, rigidity, flexibility or permeability. Such material may include for example plastic, metal, paper, wood, and or natural and/or synthetic fabric(s) and may be a material such as mesh fabric that readily permits airflow therethrough, to minimize wind resistance so that the portable structure and auxiliary structure remain stable in higher wind conditions. One material that can be used is a mesh fabric, such as made with nylon or other polymers. A mesh vinyl that may be used is known as 50's vinyl: with 50% holes, 50% material, and 50 DPI (or holes per inch). A banner can be secured to one or more sides of a frame or auxiliary structure 104, such as by way of a hook and loop (Velcro™) attachment, ties through holes (such as with grommets 250 shown in FIG. 4 or other snapping mechanisms), and/or adhesives. The interior and/or exterior of an auxiliary structure may be illuminated, so that advertising thereon can be viewed in low light conditions. Depending on the translucence of the auxiliary structure and/or even the roof of the portable structure on which the auxiliary structure sits, as few as a single light source may illuminate the interior of the portable structure, the auxiliary structure, and the area surrounding the exterior of the portable structure.

It will be appreciated that portable structures may include portable toilets, waste bins, trailers, and other moveable accommodations, temporary or portable storage buildings or containers, moveable billboards, walls, tents, kiosks, fencing, barricades, and waste bins, telephone booths, carnival or fair booths, or other portable, moveable or temporary structures.

In other embodiments, advertising material(s) may be provided on display(s) of the auxiliary structure. Such display(s) may include, for example, screen to be projected onto by for example a projector, a television or similar display panel, such as projection, LCD, LED or plasma displays. The display can output multimedia content, including images, videos and sounds. In other embodiments, a mechanical apparatus may be used to change images shown on a display, such as rotating advertisement boards. In further embodiments, an information dispensing device can be provided with the portable structure. For example, a coupon dispensing device can be provided to dispense coupons for a product or service being advertised.

Referring to FIG. 2, portable structure 100 may comprise base 150 that may comprise connection locations 152 for attachment of support apparatus such as hook and cable system 1210. Base 150 may allow portable structure 100 to be more easily moved as for example by providing attachments or lift points for fork lifts or other transportation means and may be a base for one or more portable structures 100. Connection locations 152 may be similar to connection location 1002, as described herein, and may assist indirect connection between portable structure 100 and frame 104, such as via cable and hook system 1210.

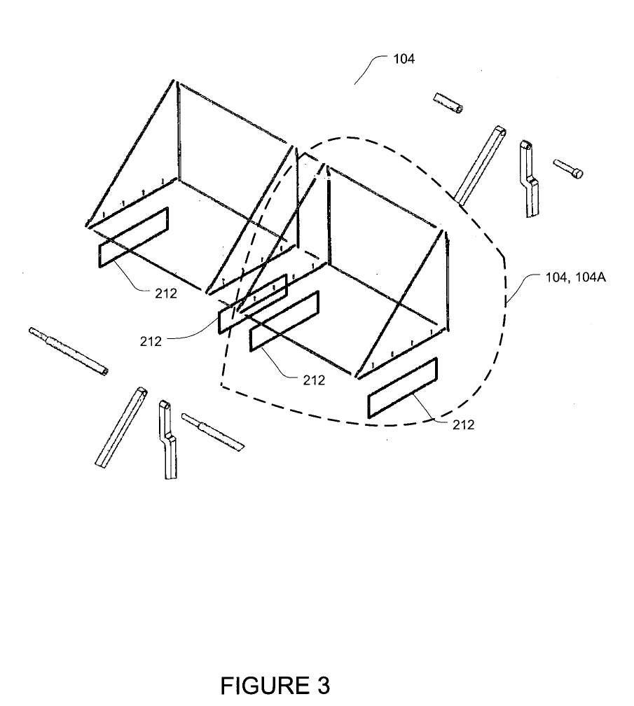

Referring to the embodiment shown in FIG. 3, it can be seen that embodiment structure 104 can be made from members including support frames 212, and other parts connected together to form a frame. Structure 104 may be comprised of one or more frame assemblies 104, 104A. Structure 104 and the component one or more frame assemblies 104, 104A may be fastened together using fastening mechanisms such as screws, quick release, adjustable length connectors, hook and loop fasteners, clamps etc. Over this frame or structure 104, advertising materials such as solid or fabric banners, wraps, or signs can be attached or mounted thereto for displaying advertisements, such as shown in FIGS. 4 to 7.

The use of support structures such as leg structures 212 can permit frame 104, and hence the auxiliary structure, to rest, such as being mounted, upon a portable structure. In such an embodiment, leg structure 212 can rest within a gutter in a roof of one or more portable structures, such as shown in FIG. 1. In the example shown in FIG. 1, two portable structures 100 are connected, with an auxiliary structure or frame 104, comprised of two frame assemblies 104, 104A placed overtop. Frame 104 sits on leg structures 212, which in such embodiments may be placed along the length of a rod or member of frame 104. Leg structures 212 may be employed in between portable structures, such as leg structures 212b in FIG. 1. Frame 104, with or without a leg structure 212, can be connected to a portable structure by gravity, a cable and bracket system as described herein, or other connection systems.

In FIG. 4, there is shown an example of a portable structure 400 with three restrooms and a frame or auxiliary structure 404 connected over the structure 400. As shown, structure 404 is covered with advertising material(s) 406, 410 to display advertisements. Such advertising material may be attached to structure 400 by many means, including for example grommets 250 and suitable rope or line. It will be appreciated that advertising materials 406, 410 can be wrapped around auxiliary structure 404 cover to create more than one area for displaying advertisements at different viewing angles. For example, there are advertisement angle surfaces, or advertising areas 406, 408 and 410 shown in the view of FIG. 4. Frame 104 can further be used to support active or electronic display devices such as LCD panels or other flat-screen displays, Cathode Ray Tubes (CRTs), etc., for displaying active advertising content using digital or other electronic means.

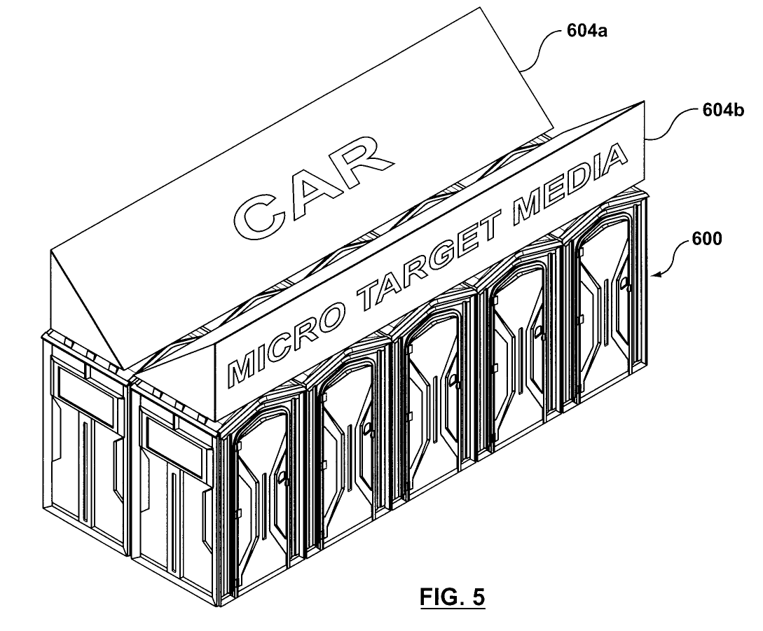

Multiple auxiliary structures or frames 104, 604 may be used, as shown in FIG. 5. Therein, ten portable restrooms are shown connected five in a row, in two rows or at least one bank connected back-to-back. Frames or auxiliary structures 104, 604a and 604b are shown connected to portable structure 600. It will be appreciated that, due to the modular nature of the auxiliary structure as shown in FIG. 3, the size and shape of an auxiliary structure can be varied to fit differing requirements. It will also be appreciated that by varying a frame or auxiliary structure, portable structure, or both, a single auxiliary structure can be crafted, such as via one or more frame assemblies 104, 104A, to span the entire portable structure or a portion thereof, or multiple auxiliary structures can span portions thereof. It will be appreciated that this flexibility provides an ability to optimize viewing angles for different venues, such as in a stadium or other venues.

The use of varying configurations in auxiliary structures 104 such as frames 404, connecting groups of portable structures in varying combinations, e.g., in banks, can also be used to increase the support and stability afforded to the portable structures, by the support structure(s) 104 and/or by adjacent portable structures.

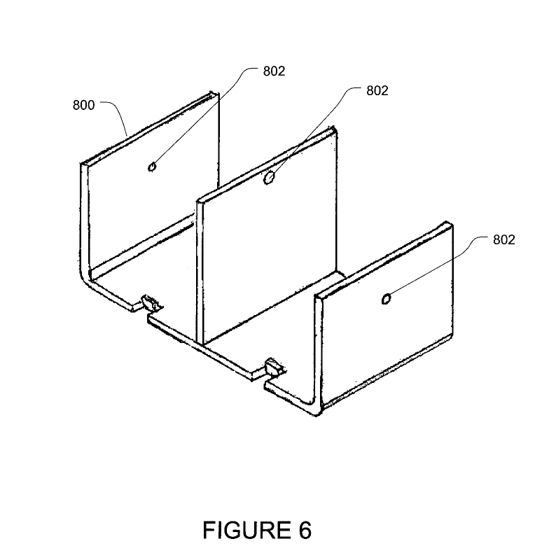

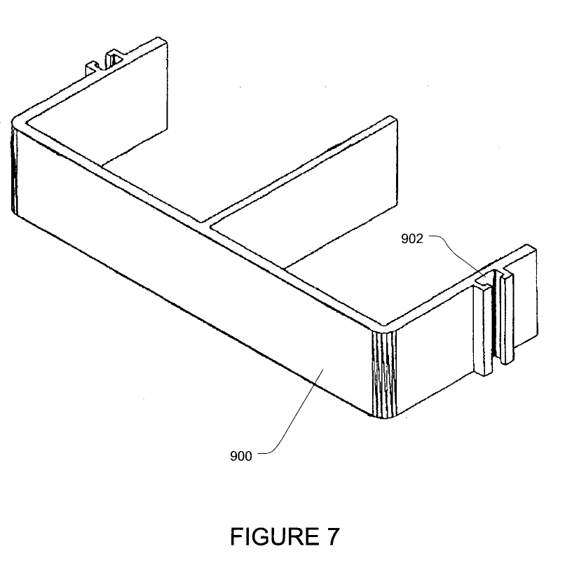

Referring to FIG. 6, bracket 800 is shown for connecting two adjacent portable structures, such as employed at location 102 shown in FIG. 1 and for anchoring one or more portable structures 100 to the ground or other support surface. Bracket 800 includes connection points 802 for use with attachment devices such as bolts, pins or other fasteners. Referring to FIG. 7, an alternate bracket embodiment 900 is shown, with alternate connection locations 902 for attachment that does not penetrate a wall of bracket 900.

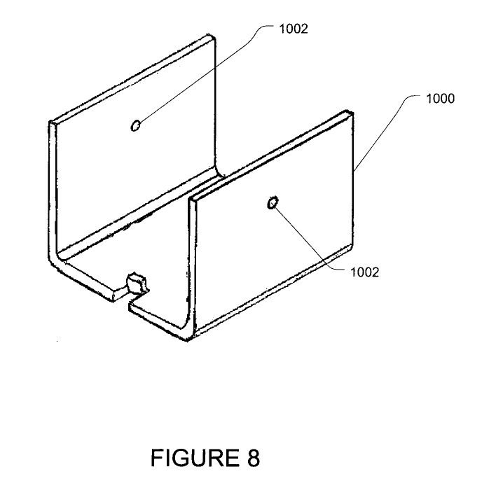

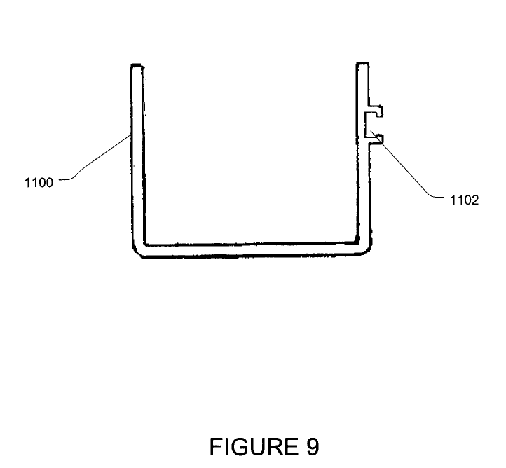

Referring to FIG. 8, extremity bracket 1000 is shown for use with walls of a portable structure, such as structure 100 shown in FIG. 1, that is an extremity wall at an end of the structure, such as wall 106 shown in FIG. 1. Bracket 1000 includes connection locations 1002. Referring to FIG. 9, an alternative extremity bracket 1100 is shown with connection locations 1102 that, like locations 1002, do not pass through a wall of bracket 1100.

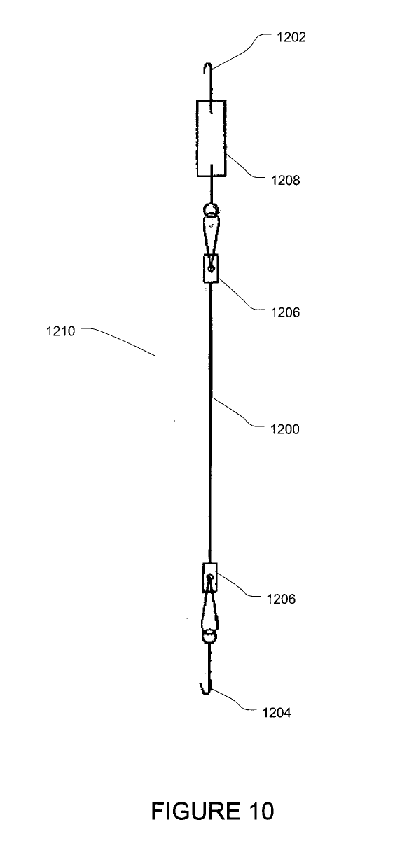

Referring to FIG. 10, a hook and cable system 1210 suitable for attaching an auxiliary structure 104 to a portable structure 120, and optionally for securing both auxiliary structure 104 and portable structure 100 to the ground or other support surface. A steel or other cable 1200 is shown connected to attachment mechanisms 1206. At one end of cable 1200, a mechanism 1206 is attached to a hook 1204 to be connected to a bottom bracket at the bottom of a wall of portable structure, such as bracket 800 attached at location 102 and bracket 1000 attached to the bottom of wall 106. Hook 1204 can engage with connection location 802 or 1002, as the case may be. In the absence of brackets, such as bracket 800, 1000, hook 1204 can engage another connection location on a grounding or support surface. Such may be, for example, a connection location (not shown) on channel 240a, 240b, or a connection location that may be directly affixed to the ground, a base or skid configured to enable transporting portable structures 100, such as base 150, or a floor surface.

At the other end of cable 1200, mechanism 1206 connects to a hook 1202 for connecting to auxiliary structure 104 through an adjustable turnbuckle 1208. It will be appreciated that turnbuckle 1208 can be located at the other end of cable 1200, and that other mechanisms for providing adjustment to length and tension of cable 1200 can be used in other embodiments.

Cable 1200 can be run through grooves in portable structure 100, direct connection including existing rain gutter grooves, to secure auxiliary structure 104 to structure 100. It will be appreciated that by using hook and cable system 1210, securing auxiliary structure 104 to structure 100 preferably does not cause any altering of, or damage to, portable structure 100 such as in the form of holes being drilled into structure 100 for use of nuts and bolts as connection mechanisms. It will be appreciated by those skilled in the relevant arts that other attachment mechanisms can be used.

It will be appreciated that hook 1202 can be connected directly to structure 104, and/or to an advertising banner placed over structure 104. For example, as shown in FIGS. 4 and 5, the advertising banner covers auxiliary structures 404 and 604, and when hooks 1202 are connected to the banners, a force is exerted on the banners to hold the auxiliary structures (404 and 604) to the portable structures (400 and 600 respectively). Again, it will be appreciated that other connection arrangements can be used in other embodiments. In an embodiment, the structure for connecting an advertising banner to can extend directly from a portable structure and may be integrated therewith.

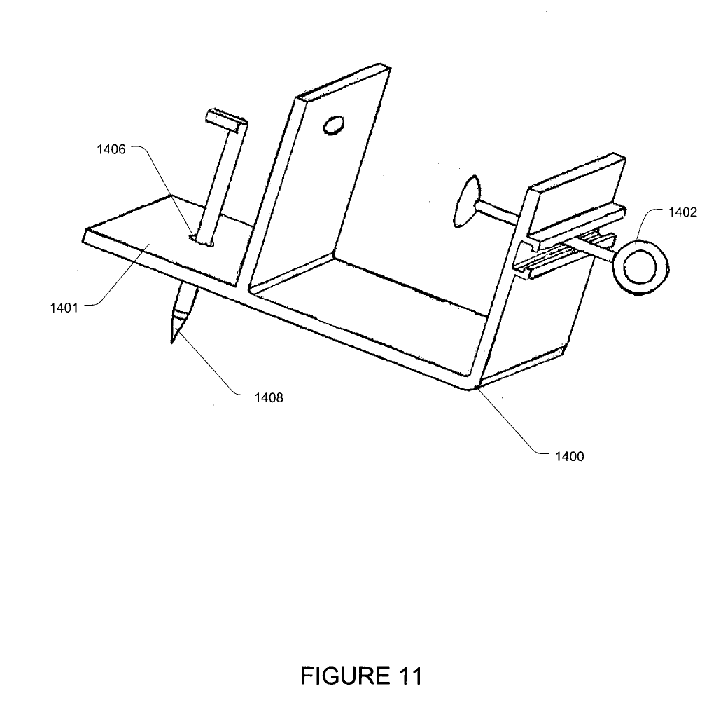

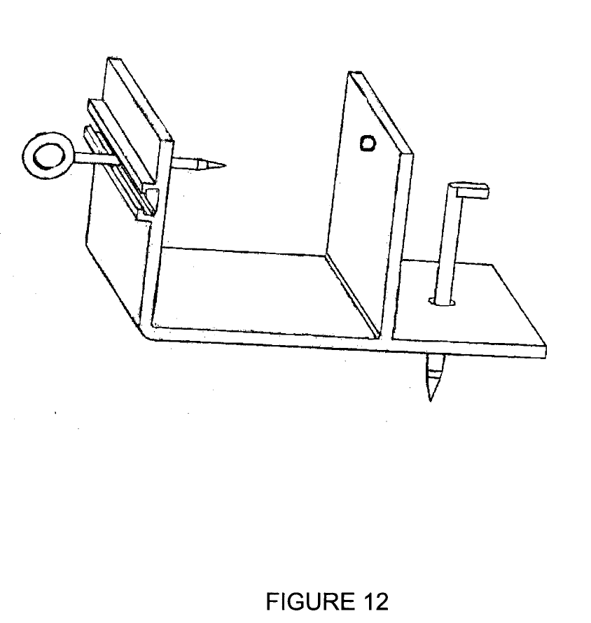

Referring to FIGS. 11 and 12, exemplary embodiments of brackets for use with a portable structure are shown. Referring to FIG. 11 as an example, bracket 1400 is similar to bracket 1000 described above. Bracket 1400 has extension 1401 with a further connection hole 1406 thereon. A pin 1408 can be used with hole 1406 to secure bracket 1400, and therefore a portable structure and auxiliary structure connected thereto, to a surface, such as a lawn of a field.

It will be appreciated that an auxiliary structure, in addition to providing advertising space, can also provide additional structural integrity to a portable structure or group of portable structures when secured thereto as described above. Additional structural integrity can be obtained by, for example, anchoring the auxiliary structure 104, either individually or along with a sidewall of a portable structure as described above with bracket 1400, to another stable surface, such as the ground or another structure nearby. Securing multiple structures to each other can provide for mutual support of the structure.

In other embodiments, one or more shims (not shown) can be provided for an auxiliary structure or groups thereof to maintain a substantial level of juxtaposition over a bank of structures for the portable structure(s) (such as structures 400 and 600 described above). This tends to be advantageous especially when the bank of structures is placed over uneven grounds or surfaces, and can, for example, allow for the improved structural functionality and/or aesthetic display of advertisements by aligning banks of portable structures 100.

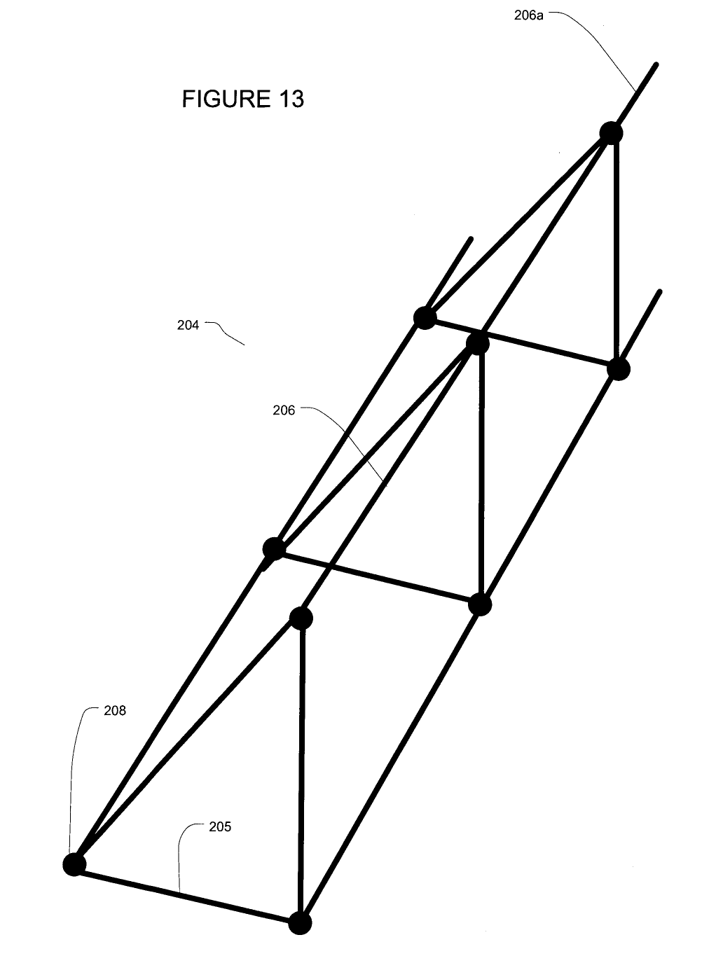

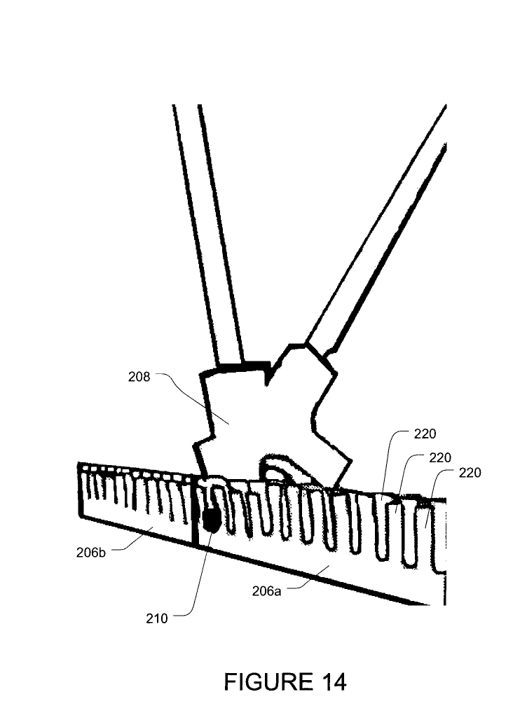

Referring to FIGS. 13 and 14, alternate embodiments of frames 204 for alternate auxiliary structures 104 are shown. Frames 204 include rods or transverse members 205 and edge posts 206 connected with connectors 208 and/or fasteners 210. Fasteners 210 may be any suitable type of bolt, screw or other fastener. It will be appreciated that multiple pieces of rods 205, longitudinal members or edge posts 206 and connectors 208, and varying dimensions and configurations of such pieces, may be used to create different sizes and shapes of frames 204, optionally from putting together one or more frame assemblies 104, 104A. As shown in FIG. 13 at 206a, frame 204 may be extended to add rods 205, edge posts 206 and connectors 208 such as to form further frame assemblies 104, 104A, for example to span further portable structures 100. This may be accomplished, for example, through the use of collapsible telescoping rods.

Connectors 208 may be provided in different configurations to provide different angles of connection to rods 205 and edge posts 206. Connector 208 may provide a large angle between rods 205 connected thereto, to allow different numbers of rods 205 and edge posts 206 to be connected in different orientations, for example to alter viewing angles. Such angle may be, for example, slightly less than 90 degrees such as 80 degrees. In a generally orthogonal direction formed by the plane of rods 205, edge post 206 may be fastened to connector 208 via a nut and bolt type fastener 210 in this exemplary embodiment. Rods 205 may be secured by a friction fit into connector 208, or by other fasteners, including glue.

In alternative embodiments, connector 208 may have smaller angles between rods 205, such as for example being approximately 46 degrees, such as if more rods 205 are connected to connector 208, such as at an internal corner. It will be appreciated that other angles may be used in other connectors 208 depending on, for example, the shape of the auxiliary structure that is desired.

FIG. 14 shows, in more detail, edge posts 206 in an exemplary embodiment. Therein, edge posts 206a and 206b are fastened to a connector 208 by fastener 210. As shown, post 206b is slightly smaller than post 206a so that post 206b can fit within post 206a to provide general adjustability, such as in length, for a frame 204. Posts 206 have teeth or tabs 220, through which fasteners 210 such as bolts and wing nuts or other quick-connect fasteners can fit. Ends of rods 205 may be covered with copper or rubber, which in various embodiments may improve friction fit with connector 208. Teeth 220 may additionally be configured to assist advertising material to be attached to frame 204, such as via clips, snaps, buckles, or the like that may be on advertising material.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

What is claimed is:

1. Apparatus for the display of advertising materials, comprising:
at least one portable structure; and
a frame removably attached to at least one exterior surface of the at least one portable structure and configured to display advertising material.

2. Apparatus according to claim 1 wherein the advertising material comprises a banner.

3. Apparatus according to claim 2 wherein at least one side of the banner is secured to at least one side of the frame.

4. Apparatus according to claim 2 wherein the banner is configured to allow air to pass therethrough.

5. Apparatus according to claim 2 configured to allow illumination of the banner.

6. Apparatus according to claim 2 wherein the advertising material comprises a mounted sign.

7. Apparatus according to claim 6 wherein the mounted sign is selected from the group consisting of a rigid sign, a metal sign, a board, a plastic sign and a poster.

8. Apparatus according to claim 2 wherein the advertising material comprises one or more electronic display devices.

9. Apparatus according to claim 8 wherein the one or more electronic display devices is selected from the group consisting of a plasma screen, a liquid crystal display (LCD) and Cathode Ray Tubes.

10. Apparatus according to claim 1 wherein the frame is mounted on the at least one portable structure.

11. Apparatus according to claim 10 wherein the frame has at least one surface for advertising material that is oriented to be viewed by an observer when outside the at least one portable structure.

12. Apparatus according to claim 1 wherein a plurality of portable structures are disposed adjacent to each other, and a single frame is attached thereto to create a bank of portable structures supporting an advertisement.

13. Apparatus according to claim 1 wherein the frame is removably attached to the at least one portable structure by one or more direct connections.

14. Apparatus according to claim 13 wherein the one or more direct connections comprises nuts and bolts, adhesives, or magnets.

15. Apparatus according to claim 1 wherein the frame is removably attached to the at least one portable structure by one or more indirect connections.

16. Apparatus according to claim 15 wherein the one or more indirect connections attach to the at least one portable structure and a foundation.

17. Apparatus according to claim 16 wherein at least one of the one or more indirect connections comprises cables, clamps or ties.

18. Apparatus for the display of advertising materials, comprising:
a frame removably attached to at least one exterior surface of at least one portable structure and configured to display advertising material.

19. Apparatus according to claim 18 wherein the advertising material comprises a banner.

20. Apparatus according to claim 19 wherein at least one side of the banner is secured to at least one side of the frame.

21. Apparatus according to claim 19 wherein the banner is configured to allow air to pass therethrough.

22. Apparatus according to claim 19 configured to allow illumination of the banner.

23. Apparatus according to claim 19 wherein the advertising material comprises a mounted sign.

24. Apparatus according to claim 23 wherein the mounted sign is selected from the group consisting of a rigid sign, a metal sign, a board, a plastic sign and a poster.

25. Apparatus according to claim 19 wherein the advertising material comprises one or more electronic display devices.

26. Apparatus according to claim 25 wherein the one or more electronic display devices is selected from the group consisting of a plasma screen, a liquid crystal display (LCD) and Cathode Ray Tubes.

27. Apparatus according to claim 18 wherein the frame is mounted on the at least one portable structure.

28. Apparatus according to claim 27 wherein the frame has at least one surface for advertising material that is oriented to be viewed by an observer when outside the at least one portable structure.

29. Apparatus according to claim 18 wherein a plurality of portable structures are disposed adjacent to each other, and a single frame is attached thereto to create a bank of portable structures supporting an advertisement.

30. Apparatus according to claim 18 wherein the frame is removably attached to the at least one portable structure by one or more direct connections.

31. Apparatus according to claim 30 wherein the one or more direct connections comprises nuts and bolts, adhesives, or magnets.

32. Apparatus according to claim 18 wherein the frame is removably attached to the at least one portable structure by one or more indirect connections.

33. Apparatus according to claim 32 wherein the one or more indirect connections attach to the at least one portable structure and a foundation.

34. Apparatus according to claim 33 wherein at least one of the one or more indirect connections comprises cables, clamps or ties.
